(19) United States
(12) Patent Application Publication
(10) Pub. No.: US 2025/0296137 A1
(43) Pub. Date: Sep. 25, 2025

(54) PRESSING TOOL

(71) Applicant: GUSTAV KLAUKE GMBH, Remscheid (DE)

(72) Inventors: Roman BOBOWICZ, Remscheid (DE); Maximilian Christians, Filderstadt (DE); Egbert FRENKEN, Heinsberg (DE)

(73) Assignee: GUSTAV KLAUKE GMBH, Remscheid (DE)

(21) Appl. No.: 18/861,771

(22) PCT Filed: May 2, 2023
(86) PCT No.: PCT/EP2023/061511

§ 371 Date: Oct. 30, 2024

(30) Foreign Application Priority Data
May 3, 2022 (DE) 10 2022 110 827.9

(51) Int. Cl. B21D 39/04

(52) U.S. Cl. CPC B21D 39/048

(57) ABSTRACT

A pressing tool includes a housing and pressing jaws arranged outside the housing. One or both pressing jaws can be pivoted into the open position by a user's hand acting upon the respective pressing jaw that faces the housing. An actuating switch is formed on a pin-like holding projection having a longitudinal extent with a free end which protrudes from the housing at an acute or right angle. A dimension of the holding projection transverse to the longitudinal extent is smaller than a smallest diameter of the hand region.

### TECHNICAL FIELD

The disclosure pertains to a pressing tool with a housing and with pressing jaws arranged outside the housing, wherein the pressing jaws can be pivoted from a closed position into an open position about a pivoting axis that is fixed relative to the housing, wherein one or both pressing jaws furthermore can be pivoted into the open position by a hand of a user by acting upon the respective pressing jaw on an end of the pressing jaw that faces the housing, wherein an actuating switch furthermore is provided and can be moved in the direction of a central longitudinal axis of the housing, on which the actuating switch is formed, in order to activate a pressing operation, wherein the actuating switch furthermore is formed on a holding projection that incidentally protrudes from the housing and the housing is to be encircled by a hand in a hand region that is assigned to the region of the actuating switch, wherein a finger of the hand reaches the actuating switch in order to act thereupon, and wherein a front face, which is partially formed by the housing and exposed toward the pressing jaws in the direction of the longitudinal axis, furthermore is realized.

### PRIOR ART

Pressing tools of the type in question are known and used, among other things, for pressing fittings on pipes, particularly in the plumbing industry, by utilizing pressing jaws that are arranged on the pressing tool and can be transferred into a closed pressing position by means of the pressing tool. It is also known to use such pressing tools for press-fitting electrical cables or for pressing on cable lugs or the like.

Such pressing tools usually are powered by accumulators, wherein only an electromotive drive can act upon the pressing jaws. However, it is also known to indirectly act upon the pressing jaws hydraulically by using a piston that can be displaced in the direction of the longitudinal axis of the housing. The activation of the electromotive drive—e.g. by utilizing a spindle—or the activation of an electric pump for conveying hydraulic oil is realized with an electric actuating switch that is arranged on the housing and can be reached by a finger of the hand of the user operating the pressing tool. In this respect, we refer, for example, to WO 2003/084719 A2 (U.S. Pat. No. 7,254,982 B2).

The pressing jaws may be held on the pressing tool in a pivotable and exchangeable manner. The pressing jaws usually are realized in the form of a pressing jaw pair that may be pivotable about a common fixed pivoting axis. In this respect, it is furthermore known to manually pivot and hold at least one of the pressing jaws, preferably both pressing jaws, in an open position, particularly for the attachment on a part to be pressed, wherein the part to be pressed can in the open position lie in the region of the resulting pressing mouth in preparation for the pressing operation. A pressing jaw pair of this type is known, for example, from DE 10 2007 041 644 B4 (U.S. Pat. No. 7,434,441 B2).

### SUMMARY OF THE DISCLOSURE

In light of the above-described prior art, an objective of the disclosure can be seen in advantageously enhancing a pressing tool of the type in question with respect to its use.

According to a first inventive idea, this objective is potentially attained with a pressing tool, in which it is proposed that the pin-like holding projection, which has a longitudinal extent with a free end, incidentally protrudes from the housing at an acute or right angle referred to the longitudinal axis starting from the housing, that a dimension of the holding projection transverse to the longitudinal extent is smaller than a smallest diameter of the hand region and that a complete circumferential clearance of the holding projection with respect to the housing is realized in a plane that extends through the holding projection perpendicular to the longitudinal extent, and that the actuating switch forms a portion of the front face.

As a result, the holding projection having the actuating switch incidentally is arranged in an exposed manner relative to the housing, particularly relative to the hand region of the housing. This holding projection may incidentally protrude from the housing like a bolt or a pin or a mandrel in a transverse direction to the longitudinal axis of the housing, which preferably also extends centrally through the hand region of the housing. With respect to a side view of the pressing tool, in which the longitudinal axis of the housing is illustrated in the form of a line and the geometric pivoting axis of the pressing jaws is in a normal basic alignment of the pressing jaws illustrated in the form of a point, a straight line that in this side view touches a front contour of the holding projection, which is oriented in the direction of the pressing jaws, on at least two points may include an acute angle, e.g., of approximately 300 and up to approximately 75°, furthermore an angle of approximately 450 or approximately 60°, with the longitudinal housing axis. In this respect, a right angle (90°) between this straight line and the longitudinal axis may also be formed.

From the connecting region of the holding projection on the housing in the direction of the free end of the holding projection, the holding projection preferably can, starting from the front face of the housing, be inclined rearward in the direction of the end of the housing facing away from the front face such that the free end of the holding projection is viewed in the direction of the longitudinal axis spaced apart further from the housing front face than the connecting region of the holding projection lying opposite of this free end.

Starting from this connecting region, the dimension of the holding projection viewed transverse to the longitudinal axis, i.e. the dimension of its longitudinal extent, is chosen smaller than the smallest transverse dimension of the housing in the hand region. For example, this longitudinal extent of the holding projection may correspond to approximately 0.95-times to 0.5-times, e.g. to approximately 0.8-times or 0.7-times, the smallest transverse dimension in the hand region.

In a cross section through the holding projection in a plane extending transverse to the above-described longitudinal extent of the holding projection, the holding projection preferably is exposed over its entire circumference. This preferably can apply to any cross section along the longitudinal extent between the connecting region and the free end of the holding projection such that the holding projection as a whole can accordingly protrude from the hand region of the housing in a bolt-like or pin-like or mandrel-like or finger-like manner, if applicable in a pin-like manner.

In a preferred actuation of the actuating switch in the direction of the central longitudinal axis of the housing, another preferred arrangement of the actuating switch is located in the region of a front face of the holding projection that points in the direction of the pressing jaws and, accordingly, in a surface that incidentally faces away from the hand region.

In this case, the actuating switch and preferably also at least a section of the holding projection accommodating the actuating switch may form a portion of the housing front face. With respect to the aforementioned side view, for example, at least a section of the holding projection respectively may run into the housing front face in the same plane as the actuating switch or form this front face in the same plane.

Due to the above-described arrangement and design of the holding projection having the actuating switch, the hand that carries and guides the pressing tool as a whole in the hand region during its operation can be advantageously prevented from slipping off forward in the direction of the pressing jaws, wherein the actuating switch on the holding projection furthermore can be reached by a finger in an ergonomically advantageous manner. The pin-like design of the holding projection and the ergonomically advantageous arrangement of the actuating switch on the side of the front face optionally make it possible to change the finger of the user's hand, which initially holds an associated pressing jaw in an open position, from the pressing jaw to the actuating switch during the preferred single-handed operation of the pressing tool. This can be achieved, for example, by practically sliding the finger in the direction of the actuating switch from the open position of the pressing jaw. An advantageous operation of the pressing tool with respect to ergonomics and handling is thereby achieved.

Other characteristics of the disclosure are frequently described below, as well as in the description of the figures, in their preferred association with the object of the claims. However, they may also be important in association with only individual characteristics of the claims.

According to a potential enhancement, a longitudinal extent of the holding projection in the longitudinal direction may be smaller than the width of a hand. For example, a longitudinal extent of the holding projection viewed in the direction of its longitudinal extent may amount to approximately 20 to 50 mm and optionally up to approximately 60 mm, e.g. to approximately 30 to 40 mm.

The preferred arrangement of the actuating switch in a surface of the holding projection that faces the pressing jaws is particularly advantageous with respect to ergonomics, but also with respect to advantageous handling of the pressing tool as a whole. In order to activate the pressing operation, the holding projection is to be intentionally encircled with a finger starting from the hand region of the housing in order to act upon the actuating switch arranged in the corresponding front face of the holding projection.

According to a potential embodiment, this actuating switch may be realized in the form of a so-called rocker switch with a rocking axis that preferably extends transverse to the longitudinal axis of the housing, particularly parallel to a pivoting axis of the pressing jaws in a normal basic alignment of the pressing jaws.

It would also be possible that the holding projection only (exclusively) retains the actuating switch. In a preferred embodiment, the holding projection accordingly has no other functional elements that can serve for directly or indirectly acting upon the operation of the pressing tool.

With respect to the above-described side view, in particular, an outer edge contour of the holding projection may in another embodiment run into a terminal edge of the housing, which generally extends perpendicular to the longitudinal axis, on the jaw side. This terminal edge of the housing preferably can form part of the front face of the housing. Furthermore, the holding projection is in this case preferably designed in such a way that it does not extend beyond the plane, which is formed by the front face of the housing and oriented perpendicular to the longitudinal axis, in the above-described side view.

In order to additionally promote advantageous handling, the respective pressing jaws may in a potential embodiment be pivotable into the open position individually. Accordingly, no direct motion coupling of the pressing jaws is realized in such an embodiment of the pressing jaws.

The pressing jaws, which accordingly are not coupled to one another, may respectively have an actuating trough for respectively inserting a finger on their ends on the housing side. In this way, the pressing jaws can be easily and safely pivoted into the open position. The user, who furthermore holds the pressing tool in the hand region of the housing, is able to pivot the pressing jaws into the open position, e.g. with the thumb and index finger, and to hold the pressing jaws in this open position, wherein the preferably provided actuating trough prevents the finger from inadvertently sliding off the respective pressing jaw.

The pressing tool can be moved toward the part to be pressed with the opened pressing jaws. The thumb, which initially holds one pressing jaw in the open position, can then be pulled back such that it contacts the hand region and participates in holding the tool. The index finger, which initially holds the other pressing jaw in the open position, practically can slide off the pressing jaw and change to the actuating switch intentionally upon the release of this pressing jaw.

The pressing jaws as a whole may be pivotable about the longitudinal axis of the pressing tool, preferably together with a receiving neck, which preferably has fork arms, and optionally a fastener, e.g. given by a bolt, which couples the pressing jaws. However, since the preferred manual actuation of the pressing jaws should for logical reasons be carried out in a chosen position, in which a pivoting plane of the pressing jaws is aligned with an extending direction of the holding projection, it is preferably also possible that such an alignment of the pressing jaws is catch-retained such that it can be overrun during a rotatability as incidentally described above. This alignment can then preferably be assumed by utilizing the catch retention.

The rotatability is also particularly advantageous if the aforementioned preferred alignment of the pressing jaws relative to the pressing device incidentally does not lead to the desired result in certain applications, i.e. if the pressing jaws therefore cannot be attached to a pressing point. However, it would alternatively also be possible to realize an embodiment, in which the pressing jaws are not pivotable about the longitudinal axis of the pressing device, i.e. in which the pressing jaws constantly and invariably assume the aforementioned sensible alignment with respect to the extent of the holding projection.

With respect to the disclosure, the ranges or value ranges or multiple ranges indicated above and below also include all intermediate values, particularly in 1/10 increments of the respective dimension, but optionally also dimensionless. For example, the indication 30 to 75° also includes the disclosure of 30.1 to 75°, 30 to 74.9°, 30.1 to 74.9°, etc., the indication 0.95-times to 0.5-times also includes the disclosure of 0.85-times to 0.5-times, 0.95-times to 0.6-times, 0.85-times to 0.6-times, etc., and the indication 20 to 50 mm also includes the disclosure of 20.1 to 50 mm, 20 to 49.9 mm, 20.1 to 49.9 mm, etc. This disclosure may on the one hand serve for defining a lower and/or upper limit of a cited range, but alternatively or additionally also for disclosing one or more singular values from a respectively indicated range.

### BRIEF DESCRIPTION OF THE DRAWINGS

The disclosure is described in greater detail below with reference to the attached drawings that, however, merely show exemplary embodiments. A component, which is described with reference to one of the exemplary embodiments and not replaced with a different component in another exemplary embodiment, is therefore also described as a potentially existing component in this other exemplary embodiment. In the respective drawings:

FIG. 1 shows a perspective view of a pressing tool according to a first embodiment;

FIG. 2 shows an exploded perspective view of a working head of a driving device part of the pressing tool with an associated pressing jaw pair;

FIG. 3 shows the pressing tool according to FIG. 1 in a side view in the direction of the arrow III in FIG. 1;

FIG. 4 shows a section along the plane of section IV in FIG. 1 concerning a closed position of the pressing jaws;

FIG. 4a shows an enlarged sectional view according to FIG. 4 through;

FIG. 5 shows a front view of the pressing tool in the direction of the arrow V in FIG. 1;

FIG. 6 shows the detail VI in FIG. 3, but concerning an open position of the pressing jaws;

FIG. 7 shows a section according to FIG. 4, but concerning the pressing jaw position in FIG. 6;

FIG. 8 shows another sectional view according to FIG. 4 concerning the pressing position;

FIG. 9 shows a detail in the form of a side view according to FIG. 5 concerning the closed position of the pressing jaws in a second embodiment;

FIG. 10 shows a view corresponding to FIG. 9, but concerning the open position of the pressing jaws;

FIG. 11 shows a sectional view according to FIG. 4, but concerning the arrangement and pressing jaw position in FIG. 10; and

FIG. 12 shows a perspective view of the pressing tool according to another embodiment.

### DESCRIPTION OF THE EMBODIMENTS

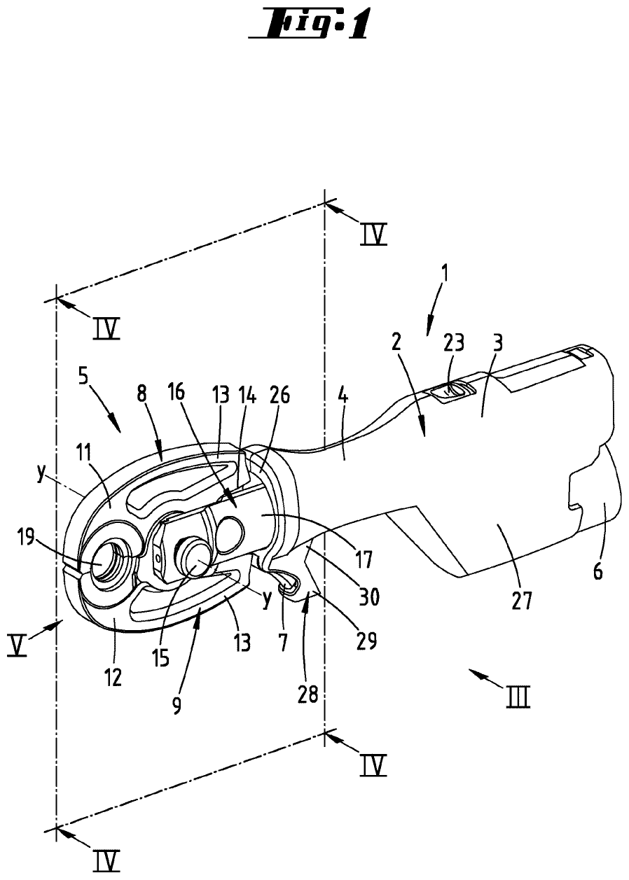

A pressing tool 1 with a rod-like design, which can be actuated electrically, particularly electro-hydraulically, is initially described with reference to the illustration in FIG. 1.

The pressing tool 1 initially and generally has a driving device part 2 with a housing 3 that has a central longitudinal axis x and a hand region 4 formed on the housing 3. Such a driving device part 2 is known, for example, from WO 2003/084719 A2 (U.S. Pat. No. 7,254,982 B2) or also from WO 2020/053 101 A1 (US 2021/0339367 A1). The complete content of these WO publications and US publications is hereby incorporated into the disclosure of the present disclosure for the purpose of incorporating characteristics of these WO and US publications into claims of the present disclosure.

A working head 5 is connected to the driving device part 2 on a free end.

The hand region 4 is designed for conventionally encircling the housing 3 by one hand of a user. An actuating switch 7 is provided in the hand region 4 in an ergonomically advantageous manner. Furthermore, an emergency switch 23 may be provided on the housing 3, e.g. for interrupting a pressing operation.

According to the figures, the working head 5 preferably includes two pressing jaws 8 and 9 that can be pivoted toward one another and away from one another. These pressing jaws 8 and 9 are pivotable about a common geometric pivoting axis y, wherein the pivoting axis y is oriented transverse to the longitudinal housing axis x. The pivoting axis y might be fixed relative to the housing 3, but can also be turnable relative to the housing 3, see further below.

The two pressing jaws 8 and 9 respectively form pressing jaw regions 11 and 12 on one side of one side of a respective bearing eye 10 of each pressing jaw and an action surface 14, particularly in the form of a cam track, on a jaw limb 13 on the other side of the respective bearing eye 10. Such a pressing jaw pair is shown, for example, in DE 10 2005 028 083 A1 (U.S. Pat. No. 7,216,523 B2), the complete content of these publications is hereby also incorporated into the disclosure of the present disclosure, namely also for the purpose of incorporating characteristics of these publications into claims of the present disclosure.

The action surfaces 14 of both pressing jaws 8 and 9 are arranged so as to face one another.

The bearing eyes 10 of both pressing jaws 8 and 9 are aligned coaxial to one another and in the assembled state and penetrated by a fastener 15, e.g. such as a locking bolt. This fastener 15 is retained in receiving bores of a receiving neck 16 of the driving device part 2 on both sides of the pressing jaws 8 and 9.

The receiving neck 16 is conventionally designed in a fork-shaped manner and has a fastener receptacle, preferably in the form of a through-bore, which extends through fork arms 17 transverse to a longitudinal extent of the receiving neck 16. The fastener 15 is retained in this fastener receptacle.

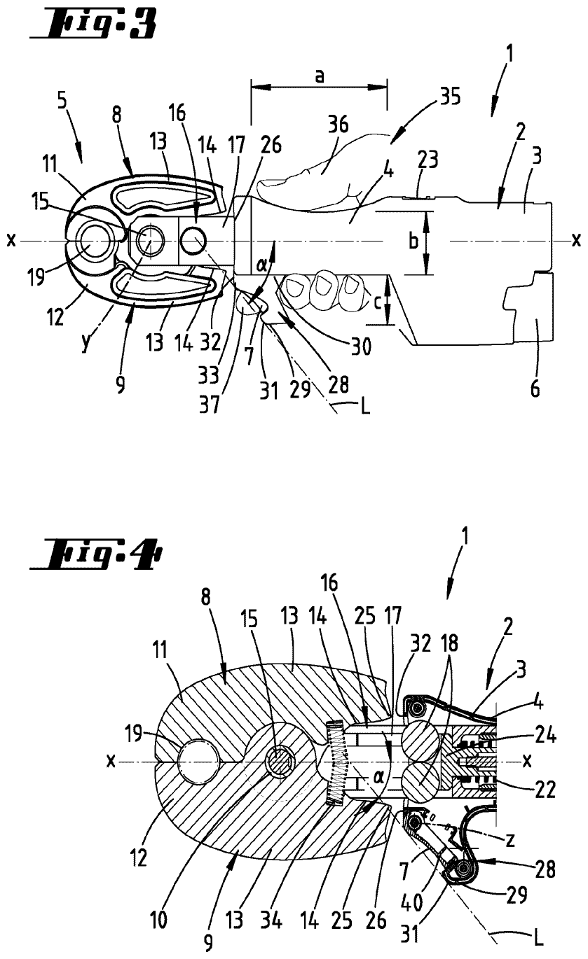

In an embodiment, the working head 5 may be arranged so as to be rotatable relative to the driving device part 2 about the longitudinal housing axis x (compare to FIG. 4a) such that the pressing tool 1 as a whole can be advantageously handled and the alignment of the pressing jaw pair 8 and 9 can be adapted to the respective circumstances. In such case, the pivoting axis y is turnable together with the fork relative to the housing 3. In each case, preferably, the pivoting axis y is fixed relative to the fork.

For example, the receiving neck 16 may be connected to a shaft 41 of the driving device part 2 by means of a plug-type connection within the housing 3. The shaft 41 may have a groove 42 extending circumferentially to the longitudinal axis x in the region overlapped by the receiving neck 16, wherein a pin 43 that is retained on the receiving neck 16 and realized, for example, in the form of a screw penetrates into the groove 42. In this way, the working head 5 is secured by means of the pin 43 and at the same time rotatable in the direction of the longitudinal axis x.

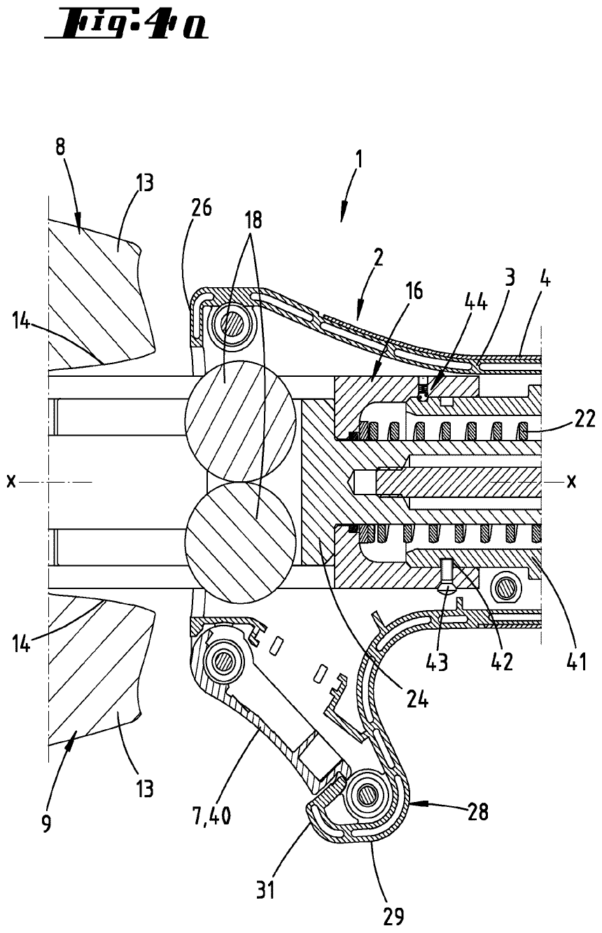

The working head 5 preferably has a basic rotational alignment relative to the driving device part 2. This basic rotational alignment preferably can be an alignment according to the illustration in FIG. 5.

For example, the basic rotational alignment may be defined by a ball catch 44, in which, for example, a ball is accommodated in the receiving neck 16 in a spring-supported manner and engages into a catch depression in the outer wall of the shaft 41. The catch mechanism can be disengaged without tools by overcoming the spring force.

The action surfaces 14 of the pressing jaws 8 and 9 protrude into the region between the fork arms 17 of the receiving neck 16 and are in the course of a pressing operation preferably acted upon hydraulically, alternatively electrically via a spindle, in the direction of rollers 18 of the driving device part 2 capable of displacing the action surfaces 14 such that the pressing jaws 8 and 9 are spread apart in the region of the action surfaces 14 and a pressing mouth 19 formed by the pressing jaw regions 11 and 12 consequently is closed in order to press a part 20 to be pressed.

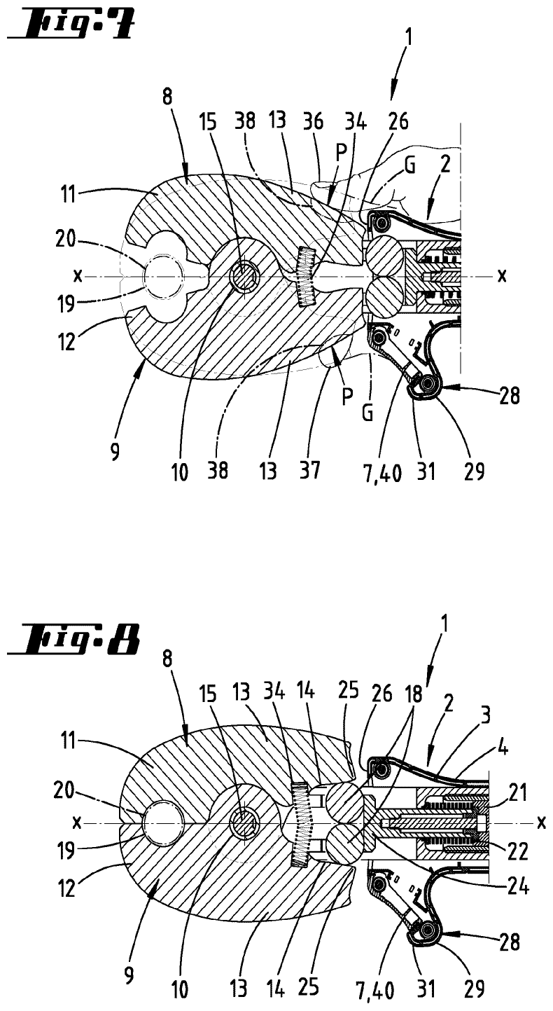

For example, a piston 21, see FIG. 8, is provided in the driving device part 2 in order to pivot the pressing jaws 8 and 9 in a closing direction of the pressing mouth 19. This piston 21 may be displaceable along the longitudinal axis x, e.g. in a hydraulic cylinder, against the force of a return spring 22. In this respect, it would also be possible, for example, to linearly drive the piston 21 along the longitudinal axis x by means of a spindle drive.

During the operation of the pressing tool 1, for example, hydraulic medium is pumped into a hydraulic cylinder via a hydraulic line upon a corresponding actuation of the actuating switch 7 in order to correspondingly act upon the front face of the piston 21 that faces the hydraulic medium. Alternatively, an electric motor may be activated, e.g. in order to drive a spindle, when the actuating switch 7 is actuated.

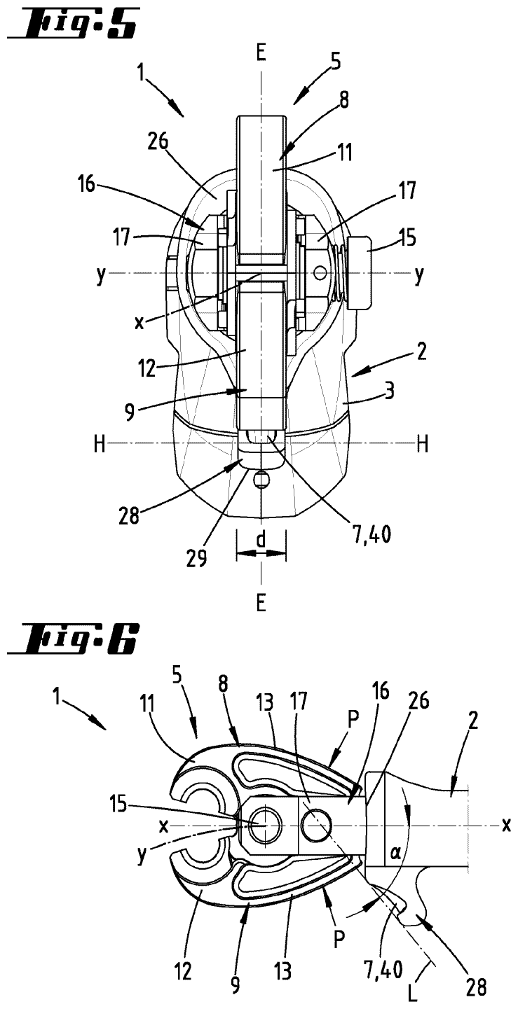

The piston 21 is displaced, e.g. against the force of the return spring 22, and moves a carrier 24 for the rollers 18 linearly along the longitudinal axis x, wherein the pressing mouth 19 is reduced in the direction of a closed position, e.g. according to FIG. 7, as the displacement travel of the rollers 18 progresses starting from a basic position, e.g. according to FIG. 4, due to the force-transmitting interaction between the rollers 18 and the cam track-like action surfaces 14 of the pressing jaws 8 and 9. The circumferential surface of each roller 18 forms an interaction surface, by which the linearly displaceable carrier 24 indirectly acts upon the action surfaces 14.

The housing 3 forms a front face 26, which generally lies in a plane extending transverse to the longitudinal axis x, on the side facing ends 25 of the jaw limbs 13 of the pressing jaws 8 and 9. This front face 26 generally delimits the hand region 4 in the direction toward the working head 5. In this context, a length a of the hand region 4 in the direction of the longitudinal axis x preferably generally conforms to a size of a conventional width of hand of a user such as 90 to 130 mm, e.g. approximately 100 to 110 mm.

Viewed transverse to the longitudinal axis x, a diameter dimension b or a smallest transverse dimension in the hand region 4 may correspond to 0.3-times to 0.6-times, e.g. to approximately 0.4-times to 0.5-times, the length a of the hand region 4 and therefore amount, for example, to approximately 40 to 50 mm.

The above-described lengths and transverse dimensions of the hand region 4 make it possible to grip the driving device part 2, as well as the pressing tool 1 has a whole, in an ergonomically advantageous manner. The working head 5 extends from the hand region 4 beyond the front face 26 in one direction and a housing section 27 of the housing 3, in which the driving components of the pressing tool 1 and the accumulator 6 are are generally positioned, extends from the hand region 4 in the opposite direction.

A holding projection 28 is integrally formed on the housing 3 on the end of the hand region 4 such that it faces the front face 26 and faces away from the housing section 27. The holding projection is formed free standing, like a bolt or a pin or a mandrel. The holding projection 28 may extend in a mandrel-like, finger-like or a pin-like manner. This holding projection 28 extends generally in a radial direction to the longitudinal axis x and furthermore is oriented and aligned with the alignment of the pressing jaw pair 8 and 9 such that the holding projection 28 and the pressing jaw 9 arranged in front thereof generally are aligned identically in a front view according to the illustration in FIG. 5. Consequently, a plane E that is aligned transverse to the pivoting axis y, contains the longitudinal axis x and centrally extends through the pressing jaws 8 and 9 may according to the illustration in FIG. 5 at the same time also generally extend through the holding projection 28 over its entire exposed length viewed transverse to the longitudinal axis x with a longitudinal extent c, see FIG. 3.

The above-described longitudinal extent c along the exposed holding projection 28 is formed starting from a connecting region 30 of the holding projection 28 on the housing 3 to a free end 29 of the holding projection 28, which faces away from the housing 3. In this context, it is furthermore preferred that such a longitudinal extent c generally is smaller than the conventional width of a hand of a user and accordingly chosen smaller than the above-described length a of the hand region 4. It is furthermore preferred that the longitudinal extent c of the holding projection 28 is chosen smaller than the smallest diameter dimension b, see FIG. 3, or the smallest transverse dimension of the hand region 4. The longitudinal extent c may have a length of approximately 20 to 50 mm and optionally up to approximately 60 mm, e.g. correspond to approximately 30 to 40 mm. For example, a corresponding longitudinal extent c may correspond to approximately 0.5-times to 0.95-times, more precisely 0.7-times to 0.95-times, e.g. to approximately 0.8-times to 0.9-times, the smallest transverse dimension b in the hand region 4.

With respect to a plane H, see FIG. 5, extending transverse to the longitudinal extent c and furthermore preferably transverse to the plane E, a clearance relative to the housing 3 is formed over the entire circumference of the holding projection 28 in another preferred embodiment, wherein this preferably applies to the entire longitudinal extent c, i.e. from the connecting region 30 to the free end 29.

Furthermore, a dimension d, see FIG. 5, of the holding projection 28 in the transversely extending plane H, i.e. a free width transverse to the longitudinal extent c, preferably is smaller than the smallest transverse dimension b in the hand region 4. For example, the dimension d may correspond to approximately 0.5-times to 0.8-times the diameter b of the hand region 4.

In a side view, from the connecting region of the holding projection 28 on the housing 3 in the direction of the free end 29 of the holding projection 28, the holding projection 28 preferably can, starting from the front face 26 of the housing 3, be inclined rearward in the direction of the end of the housing 3 facing away from the front face 26 such that the free end 29 of the holding projection 28 is viewed in the direction of the longitudinal axis x spaced apart further from the front face 26 than the connecting region 30 of the holding projection 28. In a side view, for example, according to FIG. 3, an imaginary line L, which touches an edge contour 31 of the holding projection 28 directed toward the pressing jaws 8 and 9 in two points without the edge contour 31 protruding beyond this line L starting from the holding projection 28, includes an acute angle α with the longitudinal housing axis x, wherein the angle α is approximately 30° to 75°, e.g. approximately 45° to 75°, further approximately 45° or approximately 60°. In an also embodiment, the acute angle α is 90°. Furthermore, an incline of this imaginary line L or the edge contour 31 of the holding projection 28 as a whole respectively is formed in the direction of the housing section 27 starting from the front face 26 of the housing 3.

An upper end (with reference e.g. to FIG. 4) of the outer edge contour 31 of the holding projection 28 may extend perpendicular to the longitudinal axis x and may form part of the front face 26. The upper end of the outer edge contour 31 preferably can by means of a section 32 run into a front terminal edge 33 of the housing 3 of the front face 26. The terminal edge 33 can run perpendicular to the longitudinal axis x and may form part of the front face 26, by means of the section 32. This preferably in the connection region 30 of the holding projection 28.

The actuating switch 7 is arranged in a surface of the holding projection 28 that faces the pressing jaws 8 and 9. This actuating switch 7 preferably is a rocker switch 40 with a geometric rocking axis z, which preferably is aligned in the same direction as the pivoting axis y of the pressing jaws 8 and 9.

Furthermore, the rocking axis z preferably is located in the end region of the actuating switch 7 that faces away from the free end 29 of the holding projection 28.

In another preferred embodiment, the actuating switch 7 or its actuating surface does not protrude beyond the above-described edge contour 31 of the holding projection 28. However, the actuating switch 7 or its actuating surface may touch the above-described imaginary line L at least partially such that the actuating switch 7 together with the holding projection 28, but at least the holding projection 28 in itself, can form part of the front face 26 of the housing 3 with the actuating surface facing the pressing jaws 8 and 9.

Independently of the exemplary embodiments illustrated in the figures, the holding projection 28 may only retain the actuating switch 7 as shown. Furthermore, no other elements, particularly elements for influencing the pressing operation, preferably are provided in or on the holding projection 28.

Ergonomically advantageous handling of the pressing tool 1 as a whole is achieved due to the above-described arrangement of the actuating switch 7 on a holding projection 28 that generally protrudes from the housing 3 in a pin-shaped manner.

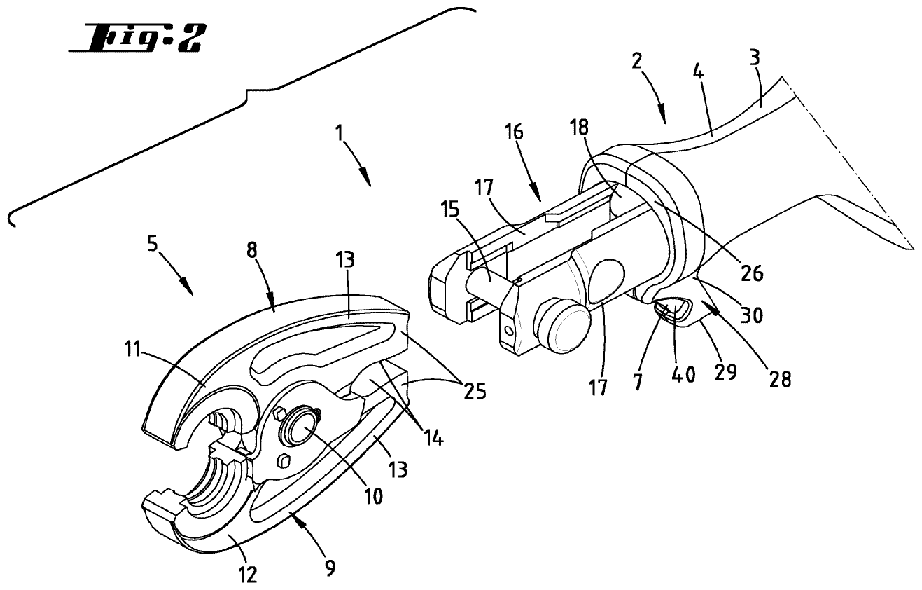

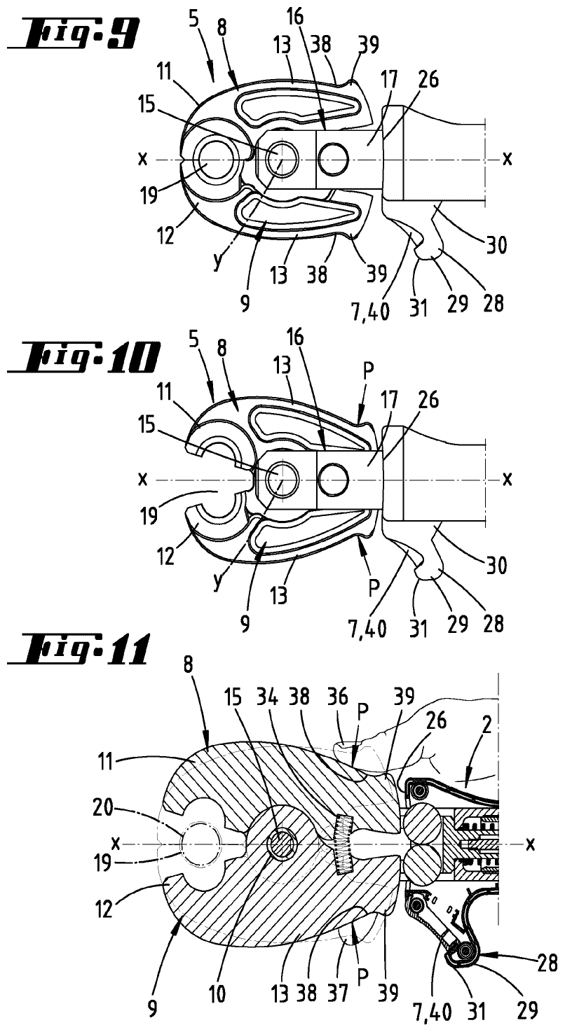

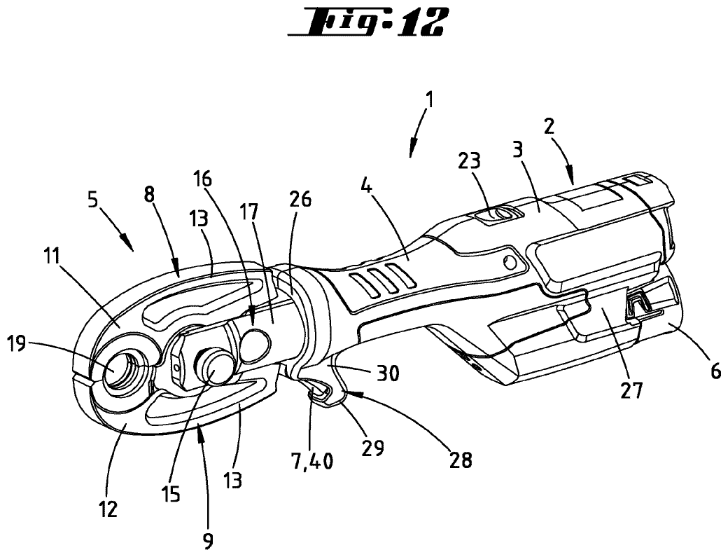

The pressing jaws 8 and 9 may be constrained into the closed position according to FIGS. 1 to 5, 9 and 12 by means of a pressure spring 34, see FIG. 8, wherein the pressing jaws 8 and 9 preferably are not motion-coupled to one another, but rather can be pivoted into the open position individually. The pressing mouth 19 accordingly is closed without any external influence. The pressing mouth 19 initially has to be opened in order to attach the pressing tool 1 to a part 20 to be pressed. The opening of the jaws 8 and 9 is realized manually by intentionally displacing the pressing jaws 8 and 9 into their open position according to FIGS. 5 to 7, 10 and 11 against the restoring force of the pressure spring 34. The opening of the jaws 8 and 9 preferably can be achieved with fingers of the user's hand 35 that simultaneously holds and guides the pressing tool 1 in the hand region 4, particularly by putting pressure on the jaw limbs 13 of the pressing jaws 8 and 9 in the region of their ends 25, wherein a thumb 36 of the user extends beyond the front face 26 and presses on the pressing jaw 8 while a finger 37, particularly the index finger, presses on the other pressing jaw 9 while encircling the holding projection 28 with the actuating switch 7 (see FIGS. 7 and 11 and the force application schematically indicated therein with the arrows P). A basically single-handed operation of the pressing tool 1 can thereby be achieved.

According to FIGS. 1 to 8, the surfaces acted upon by the thumb 36 and the finger 37 may in the region of the jaw limbs 13 be designed with a smooth surface and such that they extend evenly and generally without steps, e.g. with reference to a sectional view according to FIG. 7.

According to the illustrations in FIGS. 9 to 11, however, corrugation-like actuating troughs 38 for respectively inserting the thumb 36 and the finger 37 may alternatively be formed in these regions assigned to the ends 25 of the jaw limbs 13. Such actuating troughs 38 may be formed, for example, by depressions in the otherwise evenly extending surfaces, e.g. as indicated with dot-dash lines in FIG. 7. However, it would also be possible to form such actuating troughs 38 with elevations 39 of the actuating surfaces, which are provided in the region of the respective end 25 and forms a limitation of such actuating troughs 38, as illustrated in FIGS. 9 to 11.

The pressing jaws 8 and 9 and the pressing tool 1 as a whole can be moved toward the part 20 to be pressed while the pressing jaws are thusly held in the open position such that the part 20 is encompassed by the opened pressing mouth 19. Once the pressing jaws 8 and 9 are no longer acted upon (arrows P) by the thumb 36 and the finger 37, the pressing jaws 8 and 9 can pivot back in the direction of a closed position due to the restoring force of the pressure spring 34 such that the part 20 to be pressed is at least almost completely encircled by the pressing mouth 19.

In order to release the associated pressing jaw 8, the thumb 36 preferably is generally pulled back in the direction of the hand region 4 in order to correspondingly contact this hand region 4. The finger 37, particularly the index finger, purposefully slides from the associated pressing jaw 9 in the direction of the holding projection 28 and therefore the actuating switch 7 such that the finger 37 is in a standby position for activating the pressing operation immediately after the release of the pressing jaws 8 and 9. Due to the superimposed motions of the back-pivoting pressing jaws 8 and 9 and the retraction movement of the thumb and finger 36 and 37, the thumb 36 and the finger 37 generally can slide off continuously and preferably without having to overcome a substantial obstacle. This is schematically illustrated in FIG. 7 in the form of the partially back-pivoted pressing jaws 8 and 9, which are drawn with dot-dash lines, as well as the slide-off line G, which is likewise drawn with a dot-dash line.

The pressing operation according to the illustration in FIG. 8 is activated by pressing the actuating switch 7.

In this case, the holding projection 28 simultaneously protects the hand 35 as a whole from slipping off in the direction of the pressing jaws 8 and 9.

With respect to the disclosure, the ranges or value ranges or multiple ranges indicated above and below also include all intermediate values, particularly in 1/10 increments of the respective dimension, but optionally also dimensionless. For example, the indication 30 to 75° also includes the disclosure of 30.1 to 75°, 30 to 74.9°, 30.1 to 74.9°, etc., the indication 0.95-times to 0.5-times also includes the disclosure of 0.85-times to 0.5-times, 0.95-times to 0.6-times, 0.85-times to 0.6-times, etc., and the indication 20 to 50 mm also includes the disclosure of 20.1 to 50 mm, 20 to 49.9 mm, 20.1 to 49.9 mm, etc. This disclosure may on the one hand serve for defining a lower and/or upper limit of a cited range, but alternatively or additionally also for disclosing one or more singular values from a respectively indicated range.

The preceding explanations serve for elucidating all disclosures that are included in this application and respectively enhance the prior art independently with at least the following combinations of characteristics, wherein two, multiple or all of these combinations of characteristics may also be combined with one another, namely:

A pressing tool, which is characterized in that the pin-like holding projection 28, which has a longitudinal extent c with a free end 29, incidentally protrudes from the housing 3 at an acute or right angle α referred to the longitudinal axis x starting from the housing 3, in that a dimension d of the holding projection 28 transverse to the longitudinal extent c is smaller than a smallest diameter b of the hand region 4, in that a complete circumferential clearance of the holding projection 28 with respect to the housing 3 is realized in a plane H that extends through the holding projection 28 perpendicular to the longitudinal extent c, and in that the actuating switch 7 forms a portion of the front face 26.

A pressing tool, which is characterized in that a longitudinal extent c of the holding projection 28 is smaller than the width of a hand.

A pressing tool, which is characterized in that the actuating switch 7 is formed in a surface of the holding projection 28 that faces the pressing jaws 8, 9.

A pressing tool, which is characterized in that the actuating switch 7 is realized in the form of a rocker switch 40.

A pressing tool, which is characterized in that the holding projection 28 only retains the actuating switch 7.

A pressing tool, which is characterized in that an outer edge contour 31 of the holding projection 28 runs into a terminal edge 32 of the housing extending perpendicular to the longitudinal axis x on the jaw side.

A pressing tool, which is characterized in that the respective pressing jaws 8 and 9 are pivotable into the open position individually, and in that both pressing jaws 8 and 9 have an actuating trough 38 for inserting a thumb and/or finger 36, 37 on their ends 25 on the housing side.

All disclosed characteristics are essential to the disclosure (individually, but also in combination with one another). The disclosure of the associated/attached priority documents (copy of the priority application) is hereby fully incorporated into the disclosure content of this application, namely also for the purpose of integrating characteristics of these documents into claims of the present application. The characteristics of the dependent claims also characterize independent inventive enhancements of the prior art without the characteristics of a claim to which they refer, particularly for submitting divisional applications on the basis of these claims. The disclosure specified in each claim may additionally comprise one or more of the characteristics that were disclosed in the preceding description and, in particular, are identified by reference symbols and/or included in the list of reference symbols. The disclosure also concerns design variations, in which individual characteristics cited in the preceding description are not realized, particularly as far as they are obviously dispensable for the respective intended use or can be replaced with other, identically acting technical means.

List of Reference Symbols

| | |
|---|---|
| 1 | Pressing tool |
| 2 | Driving device part |
| 3 | Housing |
| 4 | Hand region |
| 5 | Working head |
| 6 | Accumulator |
| 7 | Actuating switch |
| 8 | Pressing jaw |
| 9 | Pressing jaw |
| 10 | Bearing eye |
| 11 | Pressing jaw region |
| 12 | Pressing jaw region |
| 13 | Jaw limb |
| 14 | Action surface |
| 15 | Fastener |
| 16 | Receiving neck |
| 17 | Fork arm |
| 18 | Roller |
| 19 | Pressing mouth |
| 20 | Part to be pressed |
| 21 | Piston |
| 22 | Return spring |
| 23 | Emergency switch |
| 24 | Carrier |
| 25 | End |
| 26 | Front face |
| 27 | Housing section |
| 28 | Holding projection |
| 29 | End |
| 30 | Connecting region |
| 31 | Edge contour |
| 32 | Terminal edge |
| 33 | Section |
| 34 | Pressure spring |
| 35 | Hand |
| 36 | Thumb |
| 37 | Finger |
| 38 | Actuating trough |
| 39 | Elevation |
| 40 | Rocker switch |
| 41 | Shaft |
| 42 | Groove |
| 43 | Pin |
| 44 | Ball catch |
| a | Length |
| b | Diameter |
| c | Longitudinal extent |
| d | Dimension |
| x | Longitudinal axis |
| y | Pivoting axis |
| z | Rocking axis |
| E | Plane |
| H | Plane |
| G | Slide-off line |
| L | Line |
| P | Arrow |
| α | Angle |

1. A pressing tool comprising:
a housing defining a central longitudinal axis;
pressing jaws arranged outside the housing, wherein the pressing jaws are configured to be pivoted from a closed position into an open position about a pivoting axis that is fixed relative to the housing, wherein one or both pressing jaws are configured to be pivoted into the open position by a hand of a user by acting upon the respective pressing jaw on an end of the pressing jaw that faces the housing;
a pin-like holding projection protruding from the housing the holding projection and having a longitudinal extent with a free end, the holding projection protruding from the housing at an acute angle relative to the longitudinal axis;
an actuating switch provided on the holding projection and configured to be moved in the direction of the central longitudinal axis of the housing in order to activate a pressing operation when acted upon by a finger of the user's hand, wherein the housing is configured to be encircled by the user's hand in a hand region of the housing having the actuating switch, and wherein a front face is partially formed by the housing and partially formed by the actuating switch and the front face is exposed toward the pressing jaws in the direction of the longitudinal axis, wherein a dimension of the holding projection transverse to the longitudinal extent is smaller than a smallest diameter of the hand region and in that a complete circumferential clearance of the holding projection with respect to the housing is realized in a plane that extends through the holding projection perpendicular to the longitudinal extent and an outer edge contour of the holding projection runs into a terminal edge of the front face of the housing and extends perpendicular to the longitudinal axis so that a finger of the user's hand, which initially holds the associated pressing jaw in the open position, can change from the pressing jaw to the actuating switch during a single-handed operation of the pressing tool, wherein this can be achieved by sliding the finger in the direction of the actuating switch from the open position of the pressing jaw.

2. The pressing tool according to claim 1, wherein the actuating switch forms a portion of the front face.

3. The pressing tool according to claim 1, wherein a longitudinal extent of the holding projection is smaller than a width of the user's hand.

4. The pressing tool according to claim 1, wherein the actuating switch is formed in a surface of the holding projection that faces the pressing jaws.

5. The pressing tool according to claim 1, wherein the actuating switch is a rocker switch.

6. The pressing tool according to claim 1, wherein the holding projection only retains the actuating switch.

7. (canceled)

8. The pressing tool according to claim 1, wherein the respective pressing jaws are pivotable into the open position individually, and in that both pressing jaws have an actuating trough configured to receive a finger of the user on ends proximate to the housing.

9. The pressing tool according to claim 2, wherein the actuating switch is formed in a surface of the holding projection that faces the pressing jaws.

10. The pressing tool according to claim 2, wherein the actuating switch is a rocker switch.

11. The pressing tool according to claim 2, wherein the holding projection only retains the actuating switch.

12. The pressing tool according to claim 2, wherein the respective pressing jaws are pivotable into the open position individually, and in that both pressing jaws have an actuating trough configured to receive a finger of the user on ends proximate to the housing.

13. The pressing tool according to claim 4, wherein the actuating switch is a rocker switch.

14. The pressing tool according to claim 4, wherein the holding projection only retains the actuating switch.

15. The pressing tool according to claim 4, wherein the respective pressing jaws are pivotable into the open position individually, and in that both pressing jaws have an actuating trough configured to receive a finger of the user on ends proximate to the housing.

16. The pressing tool according to claim 5, wherein the holding projection only retains the actuating switch.

17. The pressing tool according to claim 5, wherein the respective pressing jaws are pivotable into the open position individually, and in that both pressing jaws have an actuating trough configured to receive a finger of the user on ends proximate to the housing.

18. The pressing tool according to claim 6, wherein the respective pressing jaws are pivotable into the open position individually, and in that both pressing jaws have an actuating trough configured to receive a finger of the user on ends proximate to the housing.
